(19) United States
(12) Patent Application Publication
(10) Pub. No.: US 2023/0417196 A1
(43) Pub. Date: Dec. 28, 2023

(54) Method for Operating an Internal Combustion Engine, in Particular of a Motor Vehicle

(71) Applicant: Daimler Truck AG, Leinfelden-Echterdingen (DE)

(72) Inventors: Alexander ZINK, Esslingen (DE); Marc Oliver WAGNER, Esslingen am Neckar (DE); Thomas SCHUHMACHER, Oberhausen-Rheinhausen (DE)

(21) Appl. No.: 18/250,895

(22) PCT Filed: Oct. 6, 2021
(86) PCT No.: PCT/EP2021/077563

§ 371 Date: Apr. 27, 2023

(30) Foreign Application Priority Data
Oct. 28, 2020 (DE) 10 2020 006 622.4

(51) Int. Cl. F02D 13/02; F02D 13/04

(52) U.S. Cl. CPC F02D 13/0219; F02D 13/04; F02D 13/0273

(57) ABSTRACT

A method for operating an internal combustion engine includes first operating the internal combustion engine in a first operating state and setting a second operating state, different from the first operating state, by advancing the exhaust camshaft relative to the crankshaft by a value in comparison with the first operating state. The exhaust valve is actuated by the exhaust cam and a decompression lift of the exhaust camshaft, whereupon, in the second operating state, the cylinder assumes a function of a decompression brake by compressing a first cylinder charge in the cylinder within a respective operating cycle of the internal combustion engine and then decompressing it by a decompression travel of the exhaust valve in a region of a charge exchange top dead center. In the second operating state, the intake camshaft is retarded relative to the crankshaft by a value.

### BACKGROUND AND SUMMARY OF THE INVENTION

The invention relates to a method for operating an internal combustion engine, in particular of a motor vehicle.

Such a method for operating an internal combustion engine, in particular of a motor vehicle, is already known, for example from EP 3 077 647 B1. In the method, the internal combustion engine has at least one cylinder and at least one piston which is received in the cylinder so as to be movable in translation. At least one exhaust valve and at least one intake valve are assigned to the at least one cylinder. The internal combustion engine also has an output shaft which is configured as a crankshaft and via which the internal combustion engine can provide torques, in particular for powering the motor vehicle. Moreover, the internal combustion engine comprises at least one intake camshaft which can be driven by the crankshaft and has at least one intake cam for actuating the at least one intake valve. The internal combustion engine further comprises at least one exhaust camshaft that can be driven by the crankshaft and has at least one exhaust cam and at least one decompression lift for actuating the at least one exhaust valve. In the method, the internal combustion engine is first operated in a first operating state. In the first operating state, the internal combustion engine is operated in a combustion mode or fired mode. In this case, a second operating state, different from the first operating state, of the internal combustion engine is set by advancing the at least one exhaust camshaft by a value relative to the crankshaft compared to the first operating state. In this case, the at least one exhaust valve is actuated by means of the exhaust cam and the at least one decompression lift of the at least one exhaust camshaft, whereupon, in the second operating state, the at least one cylinder assumes the function of a decompression brake, i.e., is operated in the manner of a decompression brake. At least a first charge of the cylinder or one first cylinder charge is compressed in the at least one cylinder within a respective operating cycle of the internal combustion engine and then decompressed by means of a decompression travel of the at least one exhaust valve in the region of a charge exchange top dead center, in particular in the manner of a sufficiently known decompression brake. The first charge enters the cylinder via the exhaust valve opened by means of the exhaust cam.

The object of the present invention is to further develop a method of the type mentioned above in such a way that a particularly advantageous engine braking operation of the internal combustion engine can be realized.

In order to further develop a method of the type specified herein such that a particularly advantageous engine braking operation of the internal combustion engine can be realized, provision is made according to the invention in a first embodiment that, in the second operating state, the at least one intake camshaft is retarded relative to the crankshaft by a first value which is in a range of greater than 80 degrees crank angle and up to at most 120 degrees crank angle after the charge exchange top dead center. In other words, the at least one intake camshaft is retarded relative to the crankshaft by more than 80 degrees and at most 120 degrees, in particular by rotation. This adjustment or rotation of the at least one intake camshaft relative to the crankshaft is also referred to as phase adjustment or phase positioning, whereby the at least one intake camshaft is or can be rotated relative to the crankshaft, for example, by means of a phase adjuster known per se and also referred to as a camshaft adjuster. Analogously to the at least one intake camshaft, the at least one exhaust camshaft can be adjusted relative to the crankshaft by means of a further phase adjuster.

In order to further develop a method of the type specified herein such that a particularly advantageous engine braking operation of the internal combustion engine can be realized, provision is made according to the invention in a second embodiment that, in the second operating state, the at least one intake camshaft is retarded by a second value which is in a range of 0 degrees crank angle to 20 degrees crank angle, in particular in a range of 1 degree crank angle to 20 degrees crank angle, after the charge exchange top dead center.

In an advantageous embodiment, provision is made that a closed position of the exhaust valve following the first decompression travel, in particular directly, is reached at 40 degrees crank angle to 165 degrees crank angle after the charge exchange top dead center. This means that the at least one exhaust valve is not closed during the first decompression travel until the closed position directly following the first decompression travel and lying within the operating cycle. A point in time occurring within the respective operating cycle at which the at least one exhaust valve reaches its closed position directly following the first decompression travel corresponds to a rotational position of the crankshaft.

Within the respective operating cycle of the internal combustion engine, the piston moves exactly twice to its top dead center and exactly twice to its bottom dead center, the respective operating cycle comprising, in particular exactly, 720 degrees of crank angle, i.e., two complete revolutions of the crankshaft. Since the at least one piston reaches its top dead center twice within the respective operating cycle, in particular exactly twice, the top dead center occurs twice within the respective operating cycle, in particular exactly twice. The first occurrence of the top dead center within the respective operating cycle is referred to as the aforementioned charge exchange top dead center or gas exchange top dead center, since during the fired mode in the region of the charge exchange top dead center, an exhaust gas of the internal combustion engine resulting from the combustion of the fuel-air mixture is pushed out of the at least one cylinder by means of the at least one piston via the at least one exhaust valve and subsequently a cylinder charge comprising at least ambient air is drawn or introduced into the at least one cylinder via the at least one intake valve. A second of the occurrences of the top dead center is also referred to as the ignition top dead center, since during the fired mode of the internal combustion engine in the region of the ignition top dead center, a fuel-air mixture located in the cylinder is ignited and subsequently burnt. The respective intake and exhaust valves are known to be actuated via respective intake cams and exhaust cams.

The internal combustion engine is preferably designed as a four-stroke engine, so that the respective operating cycle has exactly four strokes. In the strokes of the internal combustion engine related to the fired mode, a first of the strokes is a so-called intake stroke or suction stroke, in which at least ambient air or air is introduced into the cylinder. During the intake stroke, the piston moves from its top dead center, in particular from the charge exchange top dead center, to the bottom dead center. A second of the strokes following the first stroke is a so-called compression stroke which is also referred to as a compression phase. During the compression stroke, the piston moves from its bottom dead center to the top dead center, in particular to the ignition top dead center, whereby the cylinder charge previously introduced into the at least one cylinder is compressed in the cylinder by means of the piston. A third of the strokes following the second stroke is also referred to as the power stroke, since during the power stroke the at least one piston is driven by an expansion of the burnt fuel-air mixture resulting from the ignition and combustion of the fuel-air mixture and is moved from the top dead center, in particular from the ignition top dead center, to the bottom dead center. This drives the crankshaft, as the piston is articulated to the crankshaft via a connecting rod. The fourth stroke following the third stroke is also referred to as the exhaust stroke or exhaust phase, since during the fourth stroke the exhaust gas resulting from the combustion of the fuel-air mixture is expelled from the at least one cylinder by means of the at least one piston via the at least one exhaust valve. The first operating state corresponds to a fired mode, for example, or the fired mode of the internal combustion engine can take place during the first operating state. During the first stroke and/or second stoke and/or third stroke, fuel can, for example, be injected directly into the cylinder to charge the cylinder with gas. During the fired mode, combustion processes occur in the cylinder during which respective fuel-air mixtures are ignited and combusted in the cylinder. Preferably, during the second operating state, the internal combustion engine is in its unfired mode so that no fuel is introduced into the cylinder and no fuel-air mixture is formed.

As is sufficiently known from the general prior art, an engine braking operation of the internal combustion engine can be realized by operating a cylinder as a decompression brake, or by the cylinder assuming the function of a decompression brake, so that the internal combustion engine is operated in the engine braking operation as an engine brake and in particular as a decompression brake. By performing or effecting the decompression travel of an exhaust valve of a cylinder, at least one cylinder charge which was previously compressed, i.e., before the decompression travel, for example during the exhaust stroke or during the compression stroke by means of the piston, can be decompressed and thus discharged from the cylinder. As a result, the compression energy contained in the compressed cylinder charge, which was previously provided by the internal combustion engine in order to compress the cylinder charge, is lost unused, at least for the most part, so that the compression energy contained in the cylinder charge cannot be used, at least for the most part, in order to move the piston from its top dead center to its bottom dead center following compression of the cylinder charge. By this operation of the cylinder as a decompression brake, a motor vehicle equipped with the internal combustion engine can be braked or an excessive increase in speed of the motor vehicle can be avoided.

It was found that the method can be used to realize a particularly advantageous engine braking torque, also referred to simply as braking torque, by means of which the motor vehicle can be braked or its speed can be restricted. In particular, the braking torque can be set by the method according to the invention to a braking value which, although greater than 0, is sufficiently low. Thus, an excessive braking effect caused by the engine brake can be avoided by means of the inventive method according to claim 1, which can be advantageous in many driving situations. In other words, a braking power of the engine brake can be precisely and variably adjusted in a wide braking torque range by means of the method, while at the same time being kept low as desired, in order to effect sufficient braking of the motor vehicle by means of the engine brake, but to be able to avoid excessive braking caused by the engine brake.

The inventive method can be used to realize a particularly advantageous engine braking torque, also referred to simply as braking torque, by means of which the motor vehicle can be braked particularly strongly or its speed can be restricted. A particularly high engine braking power can be realized.

The inventions thus make it possible to switch between a particularly high engine braking power and a particularly low engine braking power as required.

As a result of it being provided in accordance with the invention that a closed position of the exhaust valve following the first decompression travel is reached at 40 degrees crank angle to 165 degrees crank angle after the charge exchange top dead center, the at least one exhaust valve is closed particularly late after the charge exchange dead center. This means that the first decompression travel can be maintained for a particularly long time. In other words, the exhaust valve can be kept in the first decompression travel or on the first decompression travel for a particularly long time. This can be seen particularly clearly from a valve lift curve according to which the at least one exhaust valve is actuated and thus moved. A late closing of the at least one exhaust valve and the long holding of the decompression travel is expressed in the valve lift curve by a very long plateau which extends over a particularly large degree crank angle range. During this plateau, the decompression travel of the exhaust valve is set at least substantially constant. During an earlier closing of the at least one exhaust valve following the decompression travel, no plateau or a relatively short plateau is formed. The start of the first decompression travel is, for example, between 100 degrees crank angle and 80 degrees, in particular between 90 degrees crank angle and 70 degrees crank angle, before the charge exchange top dead center, which is immediately followed by the first decompression travel and finally transitions into the closed position. By maintaining the first decompression travel in the region of the charge exchange top dead center for a long time, the following advantages can be achieved: By keeping the first decompression travel open or maintaining it, pressure can be returned to the at least one cylinder from an exhaust duct in which the exhaust gas can be expelled, so that, compared to conventional methods, only a lower boost pressure is required from an exhaust gas turbocharger or from another charging device. This allows, for example, the exhaust gas turbocharger, in particular its compressor, to operate in a particularly advantageous efficiency range. The return of pressure from the exhaust duct into the cylinder is also referred to as reverse charging. Through this reverse charging, the pressure prevailing in an exhaust tract, in particular in an exhaust duct and thus for example with an exhaust manifold connected to the exhaust duct, can be kept particularly low, so that an uncontrolled opening of the exhaust valves of further cylinders can be avoided.

Furthermore, by retarding the at least one intake camshaft, it can be achieved that the at least one piston pushes a second cylinder charge, which has previously been drawn in during the intake stroke and is, for example, in the form of fresh gas or ambient air, on its way to its top dead center through the still open intake valve back to an intake side also referred to as fresh air side of the internal combustion engine. In this way, a second cylinder charge to be compressed in the cylinder can be kept low, so that less gas is decompressed during a second decompression, whereby the braking power can be kept sufficiently and advantageously low. Conventional methods and solutions usually focus on realising the highest possible braking power. In this case, a variation and in particular a setting of a sufficiently low braking power is regularly overlooked, which power, although it is greater than 0 and can thus effect braking of the motor vehicle, is at the same time sufficiently low. The method according to the invention can be used particularly advantageously to realize a variable braking power of the internal combustion engine in a greater range.

Furthermore, by retarding the at least one intake camshaft, it can achieved that a particularly high braking power is generated. The intake valve opens at or shortly after the charge exchange top dead center, with the decompression of the first cylinder charge having been substantially completed beforehand. Advantageously, the intake stroke already begins after the charge exchange top dead center, so that via the still open exhaust valve in the first decompression travel a reverse charging can be performed and so that via the open intake valve a cylinder can be charged via the intake side, whereby due to the relatively early closing of the intake valve in the compression stroke no substantial portion of the cylinder charge is pushed back into the intake and a particularly large cylinder charge leads to an increased engine braking power during a second decompression travel in the ignition top dead center.

It has proven to be particularly advantageous if a closed position of the exhaust valve directly following the first decompression travel is reached at more than 80 degrees crank angle and at the latest at 165 degrees crank angle after the charge exchange top dead center. Advantageously, the at least one exhaust valve is already closed in the intake stroke in the first decompression travel, so that no charge in the at least one cylinder is pushed back into the exhaust and a particularly effective reverse charging can take place, whereby an improved cylinder charge can be achieved for a second decompression travel.

In order to be able to set the braking power to a particularly advantageous value, in a further embodiment of the invention provision is made that, in the second operating state, the at least one exhaust camshaft is advanced relative to the crankshaft by the value in a range of 70 degrees crank angle to 110 degrees crank angle before the charge exchange top dead center in comparison with the first operating state. By advancing the at least one exhaust camshaft, it is possible to let exhaust gas flow into the at least one cylinder from the exhaust duct or from the exhaust manifold via the opened at least one exhaust valve during the power stroke and thus by means of the exhaust travel effected by the at least one exhaust cam, and then to compress the first cylinder charge in the exhaust stroke, i.e., in the crankshaft interval in which the exhaust stroke usually occurs.

Finally, in order to be able to realize a particularly advantageous engine braking operation, in a further embodiment of the invention provision is made that, in the second operating state, a further, second cylinder charge is compressed in the at least one cylinder within the respective operating cycle of the internal combustion engine and is then decompressed by means of a second decompression travel of the at least one exhaust valve in a region of an ignition top dead center. This means that decompression takes place twice per operating cycle, in particular exactly twice. Advantageously, the engine braking power can be increased by means of the two decompression travels and influenced over a wide range. Due to the at least one exhaust camshaft and thus the exhaust travel effected by means of the at least one exhaust cam being advanced relative to the crankshaft, the at least one exhaust valve opens during the exhaust stroke and remains substantially closed during the power stroke, so that the first cylinder charge formed during the power stroke can be compressed and can be decompressed at the charge exchange dead center. The second charge in the cylinder is substantially formed via the open at least one intake valve in the intake stroke, compressed in the compression stroke and decompressed at the ignition top dead center during the second decompression travel of the at least one exhaust valve.

The respective decompression travel of the at least one exhaust valve is effected, for example, by means of an actuating element, in particular in its second position. The movement of the actuating element from a first position into the second position is also referred to as connecting, in particular as connecting at least one decompression travel. The at least one decompression travel is effected, for example, by means of a brake rocker arm and the corresponding at least one decompression lift, wherein the decompression lift effecting the decompression travel is also referred to as brake cam or brake cam lift. The decompression lift can be provided as an additional cam lift on the exhaust cam. It is also conceivable to provide the at least one decompression lift as an additional cam next to the at least one exhaust cam on the at least one exhaust camshaft. Due to the respective compression and decompression of the first and second cylinder charge within the respective operating cycle, an advantageous braking power can be realized by two corresponding decompression lifts. In engine braking devices known per se, the brake rocker arm can, for example, be provided next to an exhaust rocker arm and the actuating element or the brake rocker arm in its second position can transmit the respective travel of the decompression lifts to one or two exhaust valves of a cylinder by means of a hydraulic device.

In a further embodiment of the invention it is provided that in the second operating state, in addition to the at least one first exhaust valve of the at least one cylinder, a further, second exhaust valve of the at least one cylinder is opened simultaneously by means of the exhaust cam and only the first exhaust valve of the at least one cylinder is opened by means of a decompression travel. Preferably, in particular at least or exactly one second exhaust valve is assigned to the at least one cylinder, wherein the second exhaust valve can be or is actuated analogously by means of the at least one exhaust camshaft. When the at least one exhaust camshaft is advanced, both exhaust valves are influenced simultaneously and are thus opened earlier and closed earlier during the second operating state in comparison to the first operating state. Thus, both exhaust valves of the cylinder each perform an exhaust travel that is advanced relative to the crankshaft, which corresponds to the course of the exhaust travel in the fired, first operating state. However, in a preferred embodiment of the invention, with respect to the first exhaust valve and with respect to the second exhaust valve, only one of the two exhaust valves, and in this case for example only the first exhaust valve, performs the respective at least one decompression travel or the two additional decompression travels within the respective operating cycle in addition to the exhaust travel. Thus, during the second operating state, the first and the second exhaust valves perform at least or exactly one exhaust travel within the respective operating cycle, wherein the actuating element in the second operating state only acts on the first exhaust valve in its second position and the first exhaust valve additionally performs the decompression travels. The second operating state is an advantageous braking mode, by means of which the braking power can be varied advantageously and as required.

In order to realize a particularly advantageous switchover of the internal combustion engine from the first operating state to the second operating state, it is preferably provided that, in order to set the second operating state, first an introduction, in particular an injection, of fuel into the cylinder is terminated. Then the at least one intake camshaft is retarded and thereafter the at least one exhaust camshaft is advanced. Finally, at least one decompression travel of the at least one first exhaust valve is effected. As a result, the engine braking operation can be set particularly quickly and conveniently.

In order to realize a particularly advantageous, alternative switchover of the internal combustion engine from the first operating state to the second operating state, it is preferably provided that, in order to set the second operating state, first an introduction, in particular an injection, of fuel into the cylinder is terminated. Then the at least one intake camshaft is retarded and the at least one exhaust camshaft is simultaneously advanced. Finally, at least one decompression travel of the at least one first exhaust valve is effected. In order to realize a particularly advantageous further, alternative switchover of the internal combustion engine from the first operating state to the second operating state, it is preferably provided that, in order to set the second operating state, first an introduction, in particular an injection, of fuel into the cylinder is terminated. Then the at least one exhaust camshaft is advanced and thereafter the at least one intake camshaft is retarded. Finally, at least one decompression travel of the at least one first exhaust valve is effected.

The following advantages can be realized in particular by the method according to the invention:
considerable increase and increased variability of the engine braking power compared to conventional methods;
by omitting a retarder, in particular a cooling water retarder, secondary water retarder (SWR) or oil retarder, the manufacturing costs and the fuel consumption of the internal combustion engine can be reduced;
simplified design compared to performance-enhanced braking systems;
significant increase in exhaust gas temperature with minimal drag torque with the option of selectively adjusting the heat input into the exhaust system by means of camshaft adjustment;
high degree of parity between standard and high-performance brakes;
increased reverse charging leads to higher exhaust gas temperatures and reduced cooling of the exhaust system;
engine brake power for a high-performance brake and for a standard brake could be built up modularly;
enhanced reverse charging and subsequent decompression increase exhaust gas temperatures, resulting in higher heat input into the exhaust system; this is advantageous for
exhaust gas aftertreatment, and heat input into a cooling system can be reduced with comparable braking power; and
retarder can be designed with lower braking power, such as in the case of substituting a secondary water retarder (SWR) with an oil retarder.

Further advantages, features and details of the invention emerge from the following description of preferred exemplary embodiments and on the basis of the drawings. The features and feature combinations mentioned above in the description and the features and feature combinations mentioned below in the description of the figures and/or shown in isolation in the figures can be used not only in the respectively indicated combination but also in other combinations or in isolation, without leaving the scope of the invention.

### BRIEF DESCRIPTION OF THE DRAWINGS

FIG. 1 shows a diagram illustrating a method according to the invention as per a first embodiment for operating an internal combustion engine, in particular of a motor vehicle;

FIG. 2 shows a diagram illustrating a second embodiment of the method; and

FIG. 3 shows a flowchart illustrating the method.

### DETAILED DESCRIPTION OF THE DRAWINGS

In the figures, identical or functionally identical elements are provided with the same reference signs.

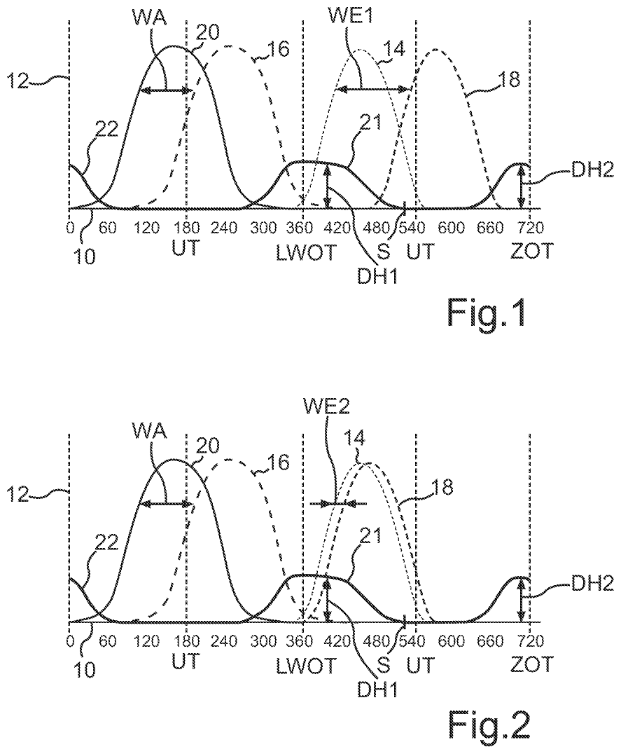

FIG. 1 shows a diagram which is used below to illustrate a first embodiment of a method for operating an internal combustion engine of a vehicle. The vehicle is designed, for example, as a motor vehicle, in particular as a commercial vehicle, and can be powered by means of the internal combustion engine, in particular in its fired mode. The internal combustion engine is designed as a reciprocating piston engine and has at least one cylinder and at least one piston which is received in the cylinder so as to be movable in translation. In particular, the internal combustion engine has a plurality of cylinders in which combustion processes take place during the fired mode of the internal combustion engine. For example, first ones of the cylinders form a first cylinder group, with second ones of the cylinders forming a second cylinder group. Thus, for example, the first group of cylinders comprises the plurality of first cylinders and the second group of cylinders comprises the plurality of second cylinders. The respective cylinder group is also referred to as a cylinder bank. In particular, the internal combustion engine can be designed as a V engine, so that the cylinders or cylinder banks can be arranged in a V shape relative to each other. Furthermore, the internal combustion engine can be designed as an inline engine, so that the cylinder banks can be arranged next to each other.

The respective piston is accommodated in the respective cylinder so that it can be moved in translation, whereby the piston can be moved in translation between a top dead center and a bottom dead center. The internal combustion engine also has an output shaft configured as a crankshaft, via which the internal combustion engine can provide torques to power the motor vehicle. The pistons are connected in an articulated manner to the crankshaft via respective connecting rods, so that the translatory movements of the pistons are converted into a rotary movement of the crankshaft. The cylinders with their respective pistons and a cylinder head each enclose a combustion chamber in which the combustion processes take place.

A respective operating cycle of the internal combustion engine configured as a four-stroke engine comprises exactly two complete revolutions of the crankshaft and thus exactly 720 degrees of crank angle. During the revolutions, the crankshaft comes into different rotational positions or rotational angles, whereby the rotational positions or rotational angles are also referred to as crank angle degrees. The respective piston moves exactly twice to its top dead center and exactly twice to its bottom dead center within the respective operating cycle, so that the top dead center occurs exactly twice within the respective operating cycle. The first occurrence of the top dead center is, for example, a so-called charge exchange top dead center LWOT. A second of the occurrences is, for example, an ignition top dead center ZOT.

Since the internal combustion engine is configured as a four-stroke engine, the respective operating cycle comprises exactly four strokes. In or in relation to the fired mode, for example, a first of the strokes is an intake stroke, also referred to as induction stroke, in which the respective piston moves from the charge exchange dead center LWOT to its respective bottom dead center UT and at least ambient air is introduced into the cylinder via the intake valves and thus a cylinder charge is introduced into the cylinder from the intake tract via the intake valves. The first stroke is followed by a second of the strokes. The second stroke is a compression stroke, also referred to as compression phase, in which the piston moves from the bottom dead center UT to its ignition top dead center ZOT. In this way, the cylinder charge previously introduced into the cylinder is compressed by means of the piston. A third stroke that follows the second stroke is a power stroke, in which the piston is driven and is moved from its top dead center ZOT to its bottom dead center UT. This results in the piston being driven as described. The fourth stroke following the third stroke is also referred to as the exhaust stroke or exhaust travel or exhaust phase, since during the fourth stroke the combusted fuel-air mixture or exhaust gas is expelled from the cylinder by means of the piston.

In addition, the internal combustion engine comprises at least one intake valve or a plurality of, in particular exactly two, intake valves per cylinder, via which, for example, at least ambient air or air or fresh air can be introduced or flow into the respective cylinder as cylinder charge. If the internal combustion engine is configured as a supercharged internal combustion engine, the cylinder charge is introduced into the cylinder via the intake valves, for example by means of a compressor of an exhaust gas turbocharger. In addition to the ambient air, for example, recirculated exhaust gas can also be contained in the cylinder charge, whereby the recirculated exhaust gas is usually mixed with the ambient air compressed by the compressor by means of high-pressure exhaust gas recirculation (HP-EGR) downstream of the compressor and/or is mixed with the introduced ambient air by means of low-pressure exhaust gas recirculation (LP-EGR) upstream of the compressor. In particular, the cylinder charge can flow from an intake manifold via intake ducts of an intake tract of the internal combustion engine into the respective cylinder, in particular when the respective intake valve is open. The internal combustion engine also comprises at least one intake camshaft that can be driven by the crankshaft and has at least one intake cam for actuating the at least one intake valve. Conventional internal combustion engines are designed as V engines or inline engines. An internal combustion engine designed as a V engine can have one intake camshaft for each cylinder bank, by means of which the respective intake valves, in particular of the respective cylinder bank, can be actuated and thus opened. V Engines with only one intake camshaft for the cylinder banks are also conceivable or designed. Typically, an internal combustion engine configured as an inline engine has only one intake camshaft for both cylinder banks.

At least one exhaust valve of the internal combustion engine is also provided for each cylinder, whereby a plurality of exhaust valves are usually provided for each cylinder and, in this case for example, exactly two exhaust valves. A cylinder charge, such as the aforementioned exhaust gas, can flow out of the cylinder via the respective exhaust valve and flow, for example, into an exhaust manifold and thus into an exhaust tract or on an exhaust side of the internal combustion engine. In this case, the internal combustion engine has at least one exhaust camshaft which can be driven by the crankshaft and has at least one exhaust cam and at least one decompression lift for actuating the at least one exhaust valve. In particular, the internal combustion engine has an exhaust camshaft, in particular for each cylinder bank of a V engine, by means of which the respective exhaust valves, in particular of the respective cylinder bank, can be actuated and thus opened. V Engines with only one exhaust camshaft for the cylinder banks are also conceivable or designed. Typically, an internal combustion engine configured as an inline engine has only one exhaust camshaft for both cylinder banks.

The at least one intake camshaft and the at least one exhaust camshaft are also collectively referred to as camshafts which can be driven by the crankshaft. In addition, the intake valves and the exhaust valves are also collectively referred to as valves or gas exchange valves. By way of example, in the exhaust tract there is an exhaust gas aftertreatment device, also referred to as an exhaust system, through which the exhaust gas can flow. The exhaust gas can be after treated by means of the exhaust system.

The diagram shown in FIG. 1 has an x-axis 10 on which the crank angle degrees are plotted. The respective gas exchange valve can be moved in translation and thus performs a respective travel within the respective operating cycle, which travel is plotted on the y-axis 12 of the diagram.

Within the context of the method, the internal combustion engine is, for example, first operated in a first operating state, in or during which the internal combustion engine is, for example, in its fired mode or in a dragged mode known per se. In or during the first operating state, the respective intake valve is actuated or moved according to a valve lift curve 14 shown in FIG. 1. In the exemplary embodiment illustrated in FIG. 1, exactly two intake valves and exactly two exhaust valves are assigned to the respective cylinder, whereby one of the exhaust valves is also referred to as the first exhaust valve and the other of the exhaust valves is also referred to as the second exhaust valve. By way of example, in the first operating state, both the first exhaust valve and the second exhaust valve are actuated or moved according to a valve lift curve 16 shown in FIG. 1. Thus, for example, the valve lift curves 14, 16 illustrate the movements or actuations of the gas exchange valves during fired mode or in the first operating state.

In the method, the internal combustion engine is switched from the first operating state to the second operating state so that the second operating state is set. The second operating state is set by retarding the intake camshaft relative to the crankshaft in comparison to the first operating state. Furthermore, in the second operating state, the cylinder is operated as, or in the manner of, a decompression brake by compressing a first cylinder charge in the cylinder within the respective operating cycle of the internal combustion engine and then decompressing it in the manner of a decompression brake by means of a first decompression travel DH1 of the first exhaust valve.

In order to be able to realize a particularly advantageous operation, in particular a particularly advantageous braking operation, of the internal combustion engine, the at least one intake camshaft is retarded by a first value WE1 in order to set the second operating state, the first value WE1 lying in a range from 80 degrees crank angle to 120 degrees crank angle. The first value WE1 is preferably greater than 80 degrees crank angle and at most 120 degrees crank angle. It is also provided that in the second operating state, the first exhaust valve reaches its closed position S immediately or directly following the first decompression travel DH1 within the respective operating cycle at a crank angle of 40 degrees to 165 degrees after the charge exchange top dead center of the piston. In other words, when the first exhaust valve reaches its closed position S immediately following the first decompression travel DH1, the crankshaft is at 40 degrees crank angle up to 165 degrees crank angle, preferably at a value greater than 80 degrees crank angle up to 165 degrees crank angle at the latest, as shown in in FIG. 1, after the charge exchange top dead center LWOT of the piston. The closed position S denotes the state of the first exhaust valves of the respective cylinders when the first exhaust valves are not open, i.e., the exhaust valve travel is zero or there is zero travel.

Since the at least one intake camshaft is retarded to set the second operating state, the intake valves, in particular all of the intake valves, assigned to the respective cylinders are moved or actuated during the second operating state in accordance with a valve lift curve 18 shown in FIG. 1. The at least one intake camshaft is adjusted or rotated relative to the crankshaft with a phase adjuster known per se. Of course, the phase adjuster for the at least one intake camshaft can also be used to adjust the intake camshaft in the first operating state.

It is further provided that for setting the second operating state, the at least one exhaust camshaft is advanced relative to the crankshaft by a value WA in comparison to the first operating state, wherein the value WA is in a range of 70 degrees crank angle to 110 degrees crank angle. In the first operating state, both exhaust valves are actuated or moved according to the valve lift curve 16. The valve lift curve 16 is effected, for example, by means of the respective exhaust cam of a respective exhaust camshaft, so that the respective exhaust valve is actuated in the first operating state by means of the respective exhaust cam.

In the second operating state, both exhaust valves of the respective cylinder continue to be actuated by means of the respective exhaust cam so that in the second operating state, both exhaust valves are actuated or moved according to a valve lift curve 20 shown in FIG. 1. The valve lift curve 20 corresponds to the valve lift curve 16, with the only difference being that the valve lift curve 20 is advanced or shifted early in comparison with the valve lift curve 16. This results from the advancement of the at least one exhaust camshaft.

To set the second operating state, for example, an actuating element assigned to the first exhaust valve is moved from the first position into a second position different therefrom, so that the first exhaust valve is actuated by means of the exhaust cam assigned to the first exhaust valve and thereby additionally by means of the decompression lift, different from the first exhaust cam, with the decompression travel DH1. As is known, the decompression lift can be designed as an additional brake cam alongside the exhaust cam or as an additional decompression lift on the exhaust cam. In this case, actuation of the first exhaust valve, effected by the exhaust cam, and simultaneously of the second exhaust valve is carried out according to the valve lift curve 20 in the second operating state. In addition, actuation of the first exhaust valve by the decompression lifts causes the first exhaust valve to be actuated and moved, respectively, to the second operating state according to a valve lift curve 21 and a valve lift curve 22. As a result, within the respective operating cycle, the first exhaust valve performs the decompression travel DH1 according to the valve lift curve 21 as first decompression travel DH1 and a second decompression travel DH2 according to the valve lift curve 22. This is explained in more detail below. Moving the actuating element from the first position to the second position is also referred to as connecting the decompression travels DH1 and DH2. The connected decompression travels DH1 and DH2 are permanently linked to the exhaust travel by their position on the crank circuit. Due to the previously described linkage, the exhaust travel and the respective decompression travel DH1 or decompression travel DH2 are shifted simultaneously, for example by a further phase adjuster, next to the phase adjuster for the at least one intake camshaft. Of course, the further phase adjuster for the at least one exhaust camshaft can be used to adjust the exhaust camshaft in the first operating state. It is also conceivable that in addition to the first exhaust valve, the second exhaust valve is also actuated in the second operating state according to the valve lift curve 21 and the valve lift curve 22, so that the second exhaust valve also performs the decompression travels DH1 and DH2. It is further conceivable that the first exhaust valve performs only one of the two decompression travels DH1, DH2, while the second exhaust valve performs the other of the two decompression travels DH1, DH2, or neither of the decompression travels DH1, DH2.

In the first embodiment, it is provided that in the second operating state the at least one cylinder is operated as a or the aforementioned decompression brake in such a way that within the respective operating cycle of the internal combustion engine in the cylinder the aforementioned first cylinder charge is compressed and thereafter decompressed by the first decompression travel DH1 of the first exhaust valve. The first cylinder charge is introduced into the respective cylinder by means of the piston via the open first exhaust valve and via the open second exhaust valve during the power stroke, and is at least partially compressed in the cylinder by means of the piston during the subsequent exhaust stroke. Compression of the first cylinder charge can take place as the exhaust valves close before the end of the exhaust stroke and the piston continues to move in the direction of the charge exchange dead center LWOT. Subsequently, the first cylinder charge is decompressed in the manner of a decompression brake by means of the first decompression travel DH1 of the first exhaust valve in the region of charge exchange dead center LWOT. Thereafter, a second cylinder charge is introduced into the cylinder during the intake stroke by means of the piston via the intake valves from the intake tract and then compressed during the compression stroke and then decompressed by the second decompression travel DH2 of the first exhaust valve in the manner of a decompression brake in the region of the ignition dead center ZOT. It is thereby provided that in the second operating state, the second decompression travel DH2 according to the valve lift curve 22 within the respective operating cycle starts at 70 degrees crank angle to 120 degrees crank angle, preferably at more than 90 degrees crank angle to 120 degrees crank angle before the ignition top dead center (ZOT). The first cylinder charge originates substantially from the exhaust tract, whereby the second cylinder charge originates substantially from the intake tract. Thus for the first decompression travel DH1, a so-called reverse charge or reverse supercharging of the respective cylinder is provided, wherein for the second decompression travel DH2, a forward charge or forward supercharging of the respective cylinder is provided.

FIG. 2 shows a second embodiment of the second operating state. In this case, the at least one intake camshaft is retarded by a second value WE2 which is in a range from 0 degrees crank angle to 20 degrees crank angle, in particular in a range from 1 degree crank angle to 20 degrees crank angle, after the charge exchange top dead center LWOT. The at least one exhaust camshaft is adjusted analogously to the first embodiment.

In internal combustion engines with, for example, two cylinder banks, each with its own intake camshaft and exhaust camshaft, the second operating state can be set for only one of the two cylinder banks or for both cylinder banks. Each of the two intake camshafts and each of the two exhaust camshafts has its own phase adjuster. It is also conceivable that different values of a phase adjustment can be set with the respective intake camshafts and exhaust camshafts of the two cylinder banks.

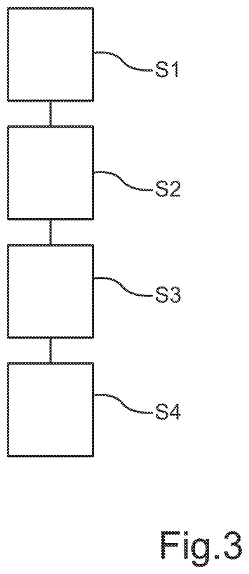

FIG. 3 shows a flowchart that is used to describe a particularly advantageous sequence for switching from the first operating state to the second operating state. By way of example, to set the second operating state, in a first step S1 an introduction, in particular an injection, of fuel into the cylinder is first terminated. Then, in a second step S2, for example, the at least one intake camshaft is retarded. Thereafter, in a third step S3, for example, the at least one exhaust camshaft is advanced. Then, in a fourth step S4, for example, at least one decompression travel DH1, DH2 of the at least one exhaust valve is effected. It is also conceivable in the exemplary embodiment shown in FIG. 3 that the third step S3 is carried out before the second step S2. Furthermore, it is conceivable that the third step S3 and the second step S2 are carried out simultaneously.

### LIST OF REFERENCE CHARACTERS

10 x-axis
12 y-axis
14 valve lift curve
16 valve lift curve
18 valve lift curve
20 valve lift curve
22 valve lift curve
DH1 first decompression travel
DH2 second decompression travel
LWOT charge exchange top dead center
S closed position
S1 first step
S2 second step
S3 third step
S4 fourth step
UT bottom dead center
WA value
WE1 first value
WE2 second value
ZOT ignition top dead center

1.-11. (canceled)

12. A method for operating an internal combustion engine, wherein the internal combustion comprises:
a cylinder and a piston which is received in the cylinder so as to be movable in translation;
an exhaust valve and an intake valve assigned to the cylinder;
a crankshaft via which a torque is providable by the internal combustion engine;
an intake camshaft which is driveable by the crankshaft and has an intake cam for actuating the intake valve;
an exhaust camshaft which is driveable by the crankshaft and has an exhaust cam and a decompression lift for actuating the exhaust valve;
and comprising the steps of:
first operating the internal combustion engine in a first operating state; and
setting a second operating state, different from the first operating state, of the internal combustion engine by advancing the exhaust camshaft relative to the crankshaft by a value (WA) in comparison with the first operating state;
wherein the exhaust valve is actuated by the exhaust cam and the decompression lift of the exhaust camshaft, whereupon, in the second operating state, the cylinder assumes a function of a decompression brake by compressing a first cylinder charge in the cylinder within a respective operating cycle of the internal combustion engine and then decompressing it by a first decompression travel (DH1) of the exhaust valve in a region of a charge exchange top dead center (LWOT);
wherein in the second operating state, the intake camshaft is retarded relative to the crankshaft by a first value (WE1) which is in a range of greater than 80 degrees crank angle and up to at most 120 degrees crank angle after the charge exchange top dead center (LWOT) or wherein in the second operating state, the intake camshaft is retarded by a second value (WE2) which is in a range of 0 degrees crank angle to 20 degrees crank angle after the charge exchange top dead center (LWOT).

13. The method according to claim 12, wherein a closed position (S) of the exhaust valve following the first decompression travel (DH1) is reached at 40 degrees crank angle to 165 degrees crank angle after the charge exchange top dead center (LWOT).

14. The method according to claim 12, wherein a closed position (S) of the exhaust valve following the first decompression travel (DH1) is reached at more than 80 degrees crank angle and at the latest at 165 degrees crank angle after the charge exchange top dead center (LWOT).

15. The method according to claim 12, wherein the exhaust camshaft is advanced relative to the crankshaft by the value (WA) in a range of 70 degrees crank angle to 110 degrees crank angle before the charge exchange top dead center (LWOT).

16. The method according to claim 12, wherein in the second operating state, a second cylinder charge is compressed in the cylinder within the respective operating cycle of the internal combustion engine and is then decompressed by a second decompression travel (DH2) of the exhaust valve in a region of an ignition top dead center (ZOT).

17. The method according to claim 12, wherein, in the second operating state, a second exhaust valve of the cylinder is opened simultaneously by the exhaust cam and only the first exhaust valve is opened by the first decompression travel (DH1).

18. The method according to claim 12, wherein, in order to set the second operating state, first an introduction of fuel into the cylinder is terminated (step S1), then the intake camshaft is retarded (step S2), and thereafter the exhaust camshaft is advanced (step S3).

19. The method according to claim 12, wherein, in order to set the second operating state, first an introduction of fuel into the cylinder is terminated (step S1), then the intake camshaft is retarded (step S2) and the exhaust camshaft is simultaneously advanced (step S3).

20. The method according to claim 12, wherein, in order to set the second operating state, first an introduction of fuel into the cylinder is terminated (step S1), then the exhaust camshaft is advanced (step S3), and thereafter the intake camshaft is retarded (step S2).

21. The method according to claim 18, wherein, after the steps (S1 to S3), a decompression travel of the exhaust valve is effected (step S4).

22. The method according to claim 19, wherein, after the steps (S1 to S3), a decompression travel of the exhaust valve is effected (step S4).

23. The method according to claim 20, wherein, after the steps (S1 to S3), a decompression travel of the exhaust valve is effected (step S4).
